(19) United States
(12) Patent Application Publication
(10) Pub. No.: US 2005/0234838 A1
(43) Pub. Date: Oct. 20, 2005

(54) Method and apparatus for providing in place editing within static documents

(76) Inventors: Nicholas H. Manousos, Santa Cruz, CA (US); Abhishek Tiwari, Santa Cruz, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/106,164

(22) Filed: Apr. 13, 2005

Related U.S. Application Data
(60) Provisional application No. 60/562,350, filed on Apr. 14, 2004.

(51) Int. Cl. G06F 17/30

(52) U.S. Cl. 705/500; 715/500

(57) ABSTRACT

A method and apparatus for in-place editing of static documents is described. The method comprises sending a “post” to the document itself, to update the display, in response to receiving a control signal.

### RELATED CASES

This patent claims the benefit of the filing date of U.S. Provisional Patent 60/562,350, and incorporates by reference that application in its entirety.

### FIELD OF THE INVENTION

The present invention relates to editing, and more particularly to in-place editing.

### BACKGROUND

Users often wish to add annotations of various sorts to static documents such as photographs, videos, etc. Furthermore, users wish to edit the data, for example crop a photograph. In the prior art, this was handled using dynamic documents, client-side logic, or scripting such as JavaScript. However, limited ability browsers such as browsers on handheld devices cannot run client-side logic such as JavaScript or dynamic documents.

### SUMMARY OF THE INVENTION

A method and apparatus for in-place editing of static documents is described. The method comprises sending a “post” to the document itself, to update the display, in response to receiving a control signal.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of one embodiment of a network in which the present invention may be implemented.

FIG. 2 is a block diagram illustrating one embodiment of the message exchange between the client and the server.

FIG. 3 is block diagram of one embodiment of the client and server.

FIG. 4 is a detailed flowchart of one embodiment of in in-place editing.

FIG. 5 is an exemplary static document including a plurality of control elements.

FIGS. 6A and 6B illustrate an exemplary static document, including the creation of a new item.

FIG. 7 is a block diagram of one embodiment of a computer system which may be used with the present invention.

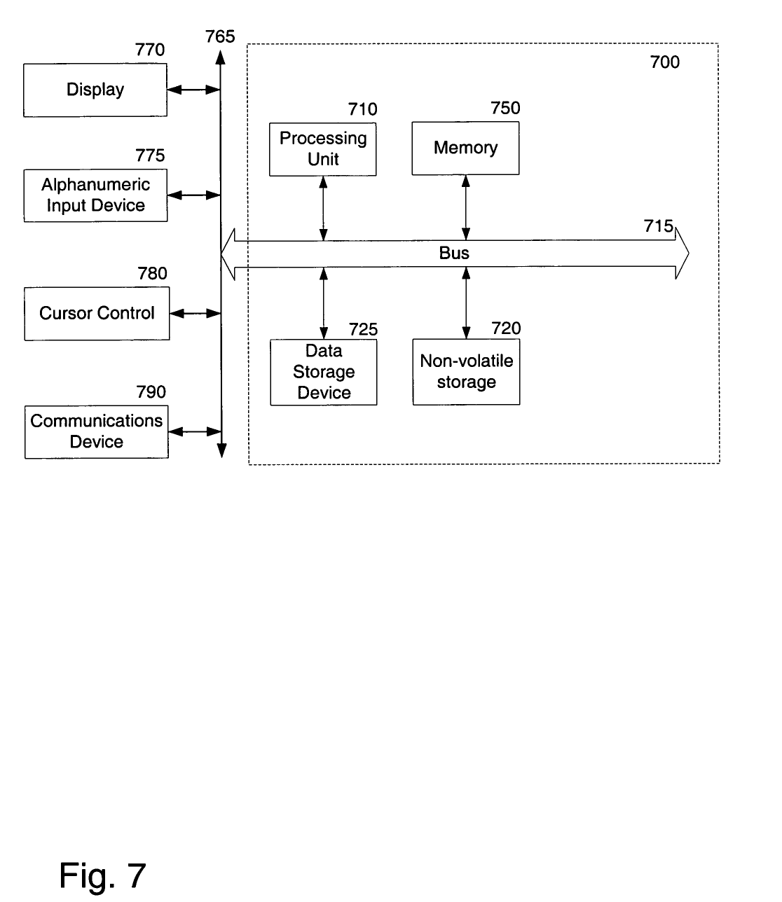

### DETAILED DESCRIPTION

A method and apparatus for providing in-place editing of static documents is described. In-place editing permits “dynamic-like” editing features, such as seeing each character as it is typed, enabling the opening of modifiable areas, etc., without using client-side logic or scripting such as JavaScript, or a similar dynamic document tool. The present invention provides interactivity without the use of client-side application control logic, i.e. scripting or logic run on the client's system. Rather, the client-side renders out as hypertext markup language (HTML) or any generalized markup language. This enables the use of such in-place editing on client devices that cannot support dynamic client-side logic.

In one embodiment, in-place editing is implemented with Java Server Pages (JSP). In another embodiment, Active Server Pages (ASP), Cold Fusion, or another format that provides pages interpreted by the server may be used. This enables the use of simple HTML, or similar display language, for the client. Thus a simple client is able to provide complex services, as is described below.

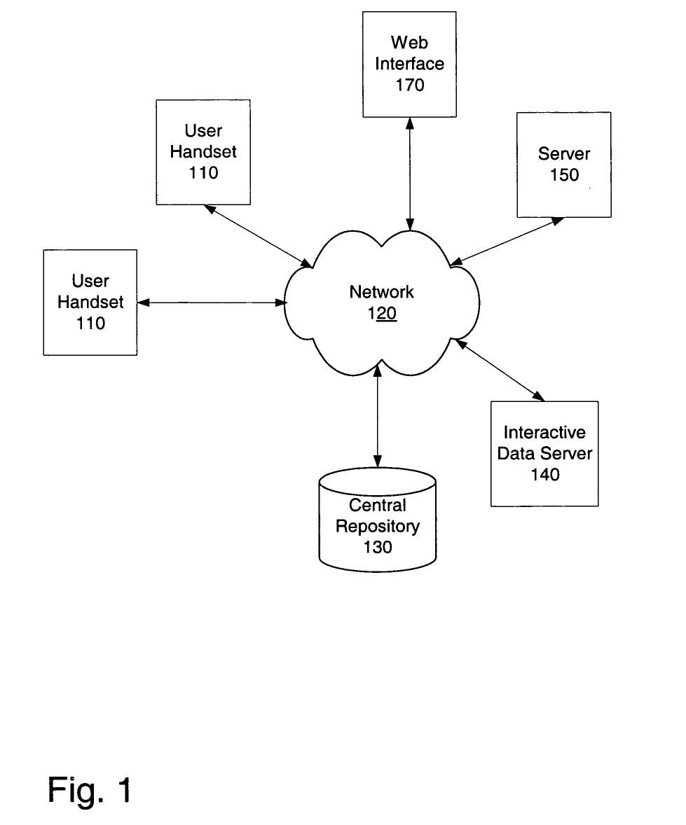

FIG. 1 is a block diagram of one embodiment of a network in which the present invention may be implemented. In one embodiment, network 120 connects user handsets 110, and/or other web interfaces 170, to server 140, 150.

In one embodiment, the inline editing feature of the present invention is available through a browser. A browser is any application and/or program that supports HTML (Hypertext Markup Language) or another mark-up type language, and is capable of accessing a server. The server 150, in one embodiment, may be on the same computer as the browser. In another embodiment, the browser's system may be coupled to the server 150 via a network 120.

Interactive data server 140 provides an HTML document, including embedded links, which enables the inline editing. The embedded links, in one embodiment, refer to JSP actions on server 140. Thus, the link, in one embodiment, is sent to the server, which interprets the JSP, and returns HTML data. This enables inline editing and interaction with static documents, such as HTML. By moving the processing to the server, a low-capability device can provide an interactive experience.

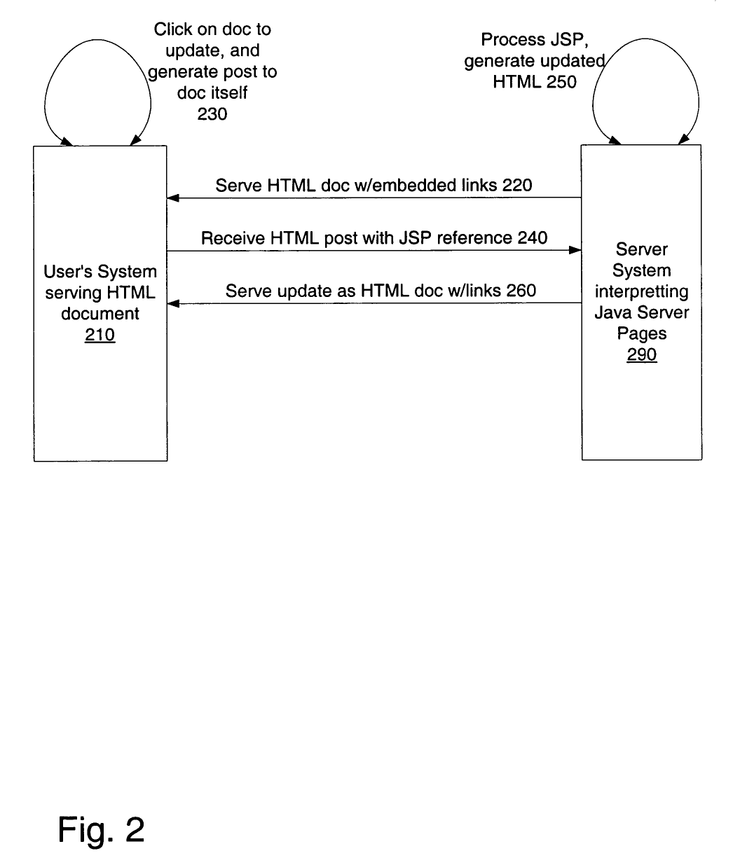

FIG. 2 is a block diagram illustrating one embodiment of the message exchange between the client and the server. Message 220 sends an HTML document with embedded links providing interactivity from the server 290 to the client 210. The client displays the HTML document to the user. The user may create an interaction by clicking on one of the activating areas. Note that the activated area may encompass the entire document. Alternatively, one or more smaller activating areas may be present.

When the user clicks on an activating area, the client system 210 generates an post, message 230. In one embodiment, the post is an HTML post. The post, in one embodiment, includes the server-interpreted data. In one embodiment, the data is JSP information. The client then posts this HTML post to itself, i.e. the server, at message 240.

The server 290 interprets the JSP, or other type of server-processed data, at message 250. In one embodiment, the JSP may instruct the server to generate a replacement page, or to generate a replacement page portion, if the HTML document includes frames or other mechanisms to trim the image into parts.

The server then sends the replacement/updated HTML document back to the user's system, as message 260. In one embodiment, since most of the data is cached on the user's system, only the updated information is sent. In one embodiment, if the data is presented in frames, only the affected frame(s) are updated.

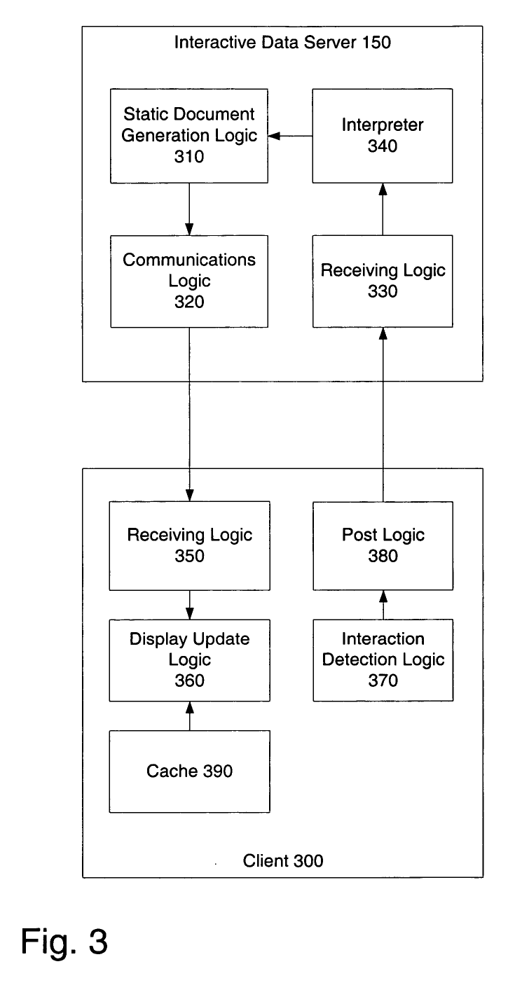

FIG. 3 is block diagram of one embodiment of the client and server. The interactive data sever 150 includes a static document generation logic. In one embodiment, the documents may be a display of multiple photographs, or similar media images. In another embodiment, any type of static image display, which can be represented by a document may be used. In one embodiment, the static document is an HTML document. Alternatively, other document formats may be used. The static document includes one or more “activating areas.” Activating areas are areas which are “interactive.” However, since the document is static, the interactivity is effectively created through server interaction.

Communications logic 320 enables the user to access the static document. In one embodiment, standard protocols are used to access the static document from the server. In one embodiment, the static document is sent via a standard protocol to the user's system.

Receiving logic 350 in the client 300 receives the data, and display update logic 360 displays the data to the user. In one embodiment, the user may access these documents in the background, and the display may be triggered by a separate interaction. In one embodiment, display update logic 360 caches the image elements in the static document.

Interaction detection logic 370 determines if a user has interacted with an activating area. In one embodiment, the activating area may be selected using a mouse click, keyboard entry, touch pad, or other method. If an interaction is detected, interaction detection logic 370 identifies the activation area associated with the interaction. The link associated with that activation area is then sent by post logic 380 to the server 150.

Receiving logic 330 in the server 150 receives the post data. In one embodiment, the post data includes an action for the server. In one embodiment, the post data includes JSP (Java Server Pages) or similar executable programs. In one embodiment, the post data includes a Java servlet.

Interpreter 340 performs the actions indicated by the servlet, and interprets the results. Interpreter 340 then passes the relevant data to static document generation logic 310. Static document generation logic 310 generates an update to be sent to the user. In one embodiment, the update may be only to part of a document. Alternatively, the entire document may be updated. In one embodiment, only those portions of the data that are not already cached by the client 300 are included by static document generation logic 310. Communications logic 320 then sends the update to the client. Display update logic 360 then updates the user's display accordingly.

In one embodiment, the above process is extremely fast, since the amount of data being sent is very small. Therefore, the update happens almost instantaneously, from the perspective of the user.

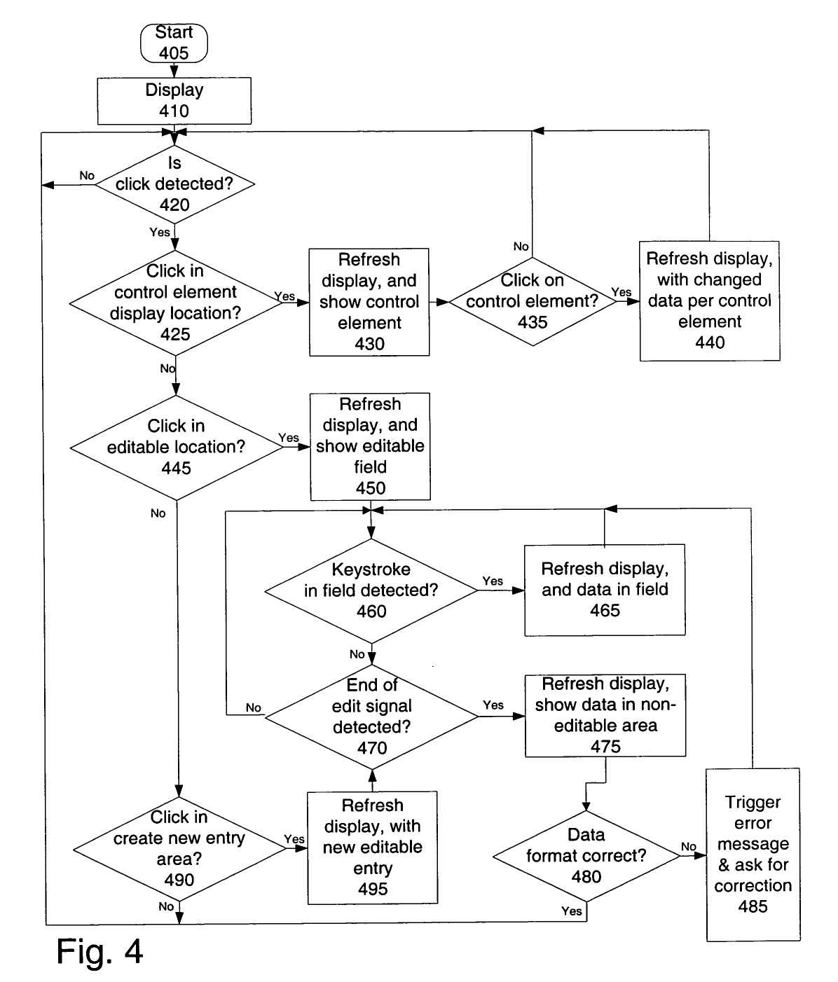

FIG. 4 is a flowchart of one embodiment of in-place editing. The process starts at block 405. At block 410, the static document is displayed. The term “static document” refers to elements that are fixed and not capable of changing. Static documents generally only display the data that is written into the HTML (hypertext markup language) or similar language which defines layout. Static documents are defined in opposition to “dynamic documents” which include content that a user can interact with. Generally, static documents are not user modifiable.

At block 420, the process determines whether a click is detected. A “click” may be a mouse click, a button indicating action, a key combination, or any other triggering mechanism that indicates that the user wishes to interact with the document.

If no click was detected, the system returns to block 420, and continues to monitor for a click.

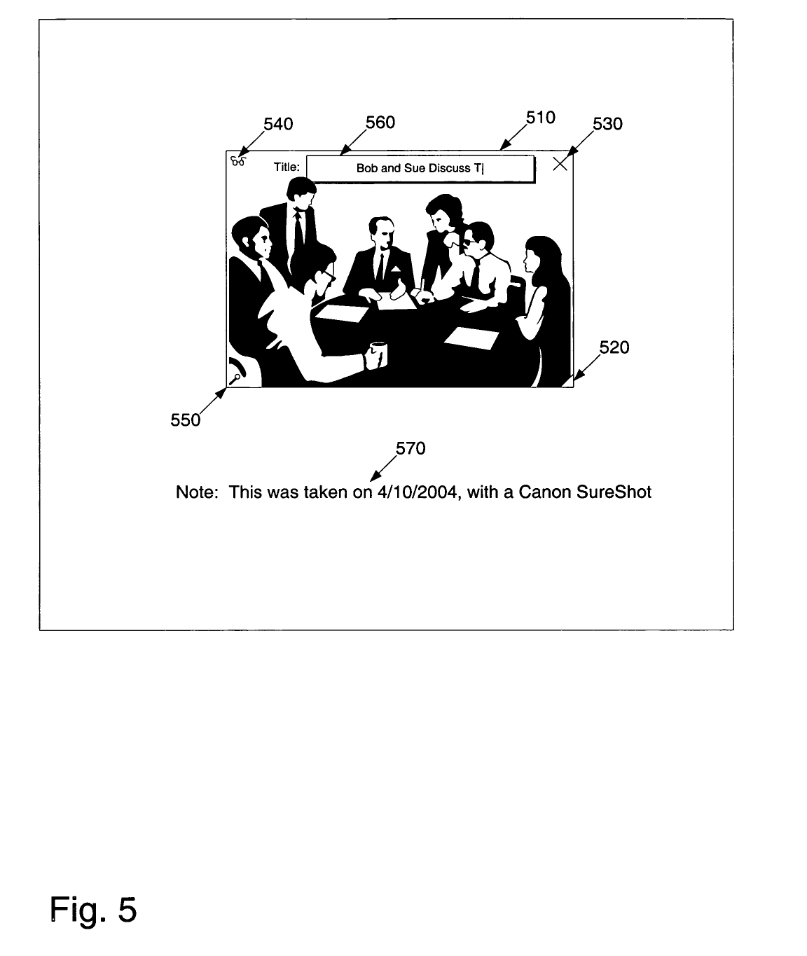

If a click was detected, the process continues to block 425. At block 425, the process determines whether the click was at the location of an “activating area.” In one embodiment, the static document may include one or more “activating areas.” For example, in the document 510 shown in FIG. 5, there are a number of exemplary activating areas. In the example shown in FIG. 5, the following activating areas are shown:
right bottom corner 520 activates a “document flip”
right top corner 530 activates a “document close”,
top left corner 540 makes filters available,
bottom left corner 550, makes image manipulation tools available, and
top center 560, a text area enables adding a title or description

Of course, the areas, icons, and actions are merely exemplary. The activating areas may be in other locations, and the icons shown are simply exemplary. For example, the activating areas may be outside the image or document being displayed. The activating area may consist of the entire image area; that is the “control elements” would be made available when the user clicks on the image, in any location. Note that although the term “image” or “image area” is used, and the example illustrated is a photographic image, the actual data displayed by the static document may be any media object or other data element.

If a click was detected in the activating area, the process continues to block 430. At block 430, the display is refreshed, and the control elements are shown.

In one embodiment, the entire document is refreshed, and the new data is displayed. In one embodiment, each of the activating areas is a “hot spot” that corresponds to a link. When the user clicks on the link, the URL associated with the “hot spot” is posted. In one embodiment, the URL is a complex URL including control signals/requester parameters, which is constructed by the server when the HTML document is created. In one embodiment, the posted URL causes the associated JSP to be interpreted by the receiving server. The receiving server interprets the JSP, and responds to the user with plain HTML data that includes the appropriate control images is sent to the client, to refresh the web page. The plain HTML data includes any relevant “hot spots” that are available on the refreshed web page. Note that because most of the data on the page is in the local cache, the refresh is very fast.

In one embodiment, the document may be split into “frames.” For example, if multiple images are displayed, each image may be in a different frame. These frames may not be visible to the user. In that instance, only the frames that are changed are updated. In one embodiment the refresh is accomplished by passing messages that define the updated interface. In one embodiment, the update is performed by sending a “post” command in an HTML document to the document. The server, in one embodiment, executes the JSP/server page, and serves simple HTML to the client, to update the user interface.

The process then returns to block 420, to wait for another click.

If the click was not in a control element display location, at block 425, the process continues to block 445. At block 445, the process determines whether the click was in an editable location. In one embodiment, the static document includes one or more defined “editable areas.” For example, in FIG. 5, the document 510 includes a “title area” 560, which is editable. The screen shown in FIG. 5 also includes an “annotation area” 570 outside the image itself, which may be editable. If the user clicks in the editable location, the process continues to block 450. Otherwise, the process continues to block 490.

If the click was in an editable location, the process continues to block 450. At block 450, the display is refreshed, and an editable field is shown. FIG. 5 shows editable field 560. As discussed above, either the entire screen may be refreshed, or the cell in which the new data is shown may be refreshed. The editable field, in one embodiment, is a shadow box, which indicates to the user that edits may be performed on the field. In another embodiment, this step may be skipped, and the user may type into a non-editable appearing area.

At block 460, the process determines whether a keystroke is detected. If so, at block 465, the display is refreshed, and the editable field now shows the newly added character. As described above this may be a full-screen refresh or an area of interest refresh. The process then returns to block 460, to determine whether a keystroke is detected.

If no keystroke is detected, at block 460, the process continues to block 470. At block 470, the process determines whether an “end of editing” action is detected. In one embodiment, a carriage return is used to indicate the end of editing. In one embodiment, the “end of editing” may be indicated by clicking on an “editing completed” button, or otherwise indicating that the editing has been completed. If the “end of editing” action is detected, the process continues to block 475. At block 475, the display is refreshed. The field is shown as “non-editable” with the updated data entered by the user.

At block 480, the process in one embodiment, determines whether the data entered is in the correct format. For example, the editable field may be a telephone number, or email address. If the editable field has a specific format associated with it, it is error checked, to ensure that it is in the correct format. If it is not in the correct format, at block 485, an error message is displayed, and the user is asked to make the correction. The process then returns to block 460 to detect a keystroke.

If the data is in the correct format at block 480, the process returns to block 420. FIG. 5 shows edited field 570, which is shown as “non-editable.

If no “end of editing” signal is detected at block 470, the process returns to block 460 to await the next keystroke. In one embodiment, the process includes a “time-out feature” which after a period of time has elapsed without either a keystroke or a carriage return, terminates the editing, continuing to block 475, to update the field to non-editable, and then returns to block 420, to await the next action.

If, at block 445, the process determined that the click was not in an editable location, the process continued to block 490. At block 490, the process determines whether the click was in an area to indicate that a new entry should be created. In one embodiment, the user may create new entries. For example, if the data being displayed is contact information for friends, the user may, in addition to editing existing “cards” as described above, add a new card.

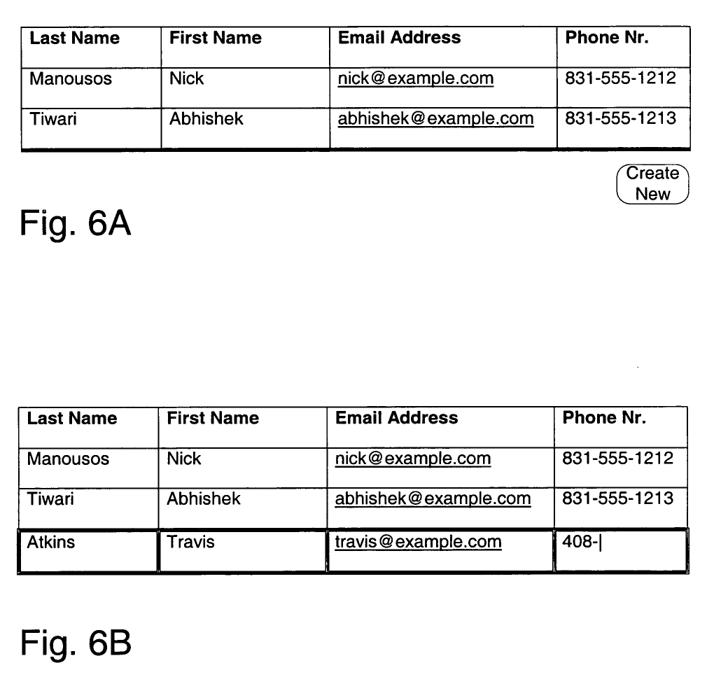

FIGS. 6A and 6B illustrate an example of creating a new card. If the user clicks in the area designated “create new” a new object is added. In one embodiment, the “create new” area is a separate area, which is displayed as a button, hyperlink, or in another way. In another embodiment, a “+” sign or other symbol may be placed somewhere, such as at the end of a line, to define a “create new” area. When a new area is created, in one embodiment, each of the fields is editable. In one embodiment, the “end of editing” signal discussed at block 470 only applies when the user is in the last field. In one embodiment, an alternative signal is used to navigate between fields. In one embodiment, the alternative symbol is a tab character.

If the user clicks on the create-new area, the process continues to block 495. At block 495, the display refreshes, and the newly added item is shown, with editable fields. The process then continues to block 470.

Note that while the above processes were described in flowchart form, they do not rely on “loops” or similar flowchart constructs. Rather, an interrupt driven mechanism may be used to monitor for clicking, key strokes, “end of edit” signals, etc. One of skill in the art would further understand that while the representation is linear, many of these processes can be performed simultaneously, and the user may skip from one process to another.

Note that although this flowchart was described using specifics (i.e. keystrokes, carriage returns, tabs, cursor selections) one of skill in the art would understand that alternative means of entering data, indicating the end of editing, or selecting options may be used. These options include touch-screens, Graffiti or other writing-based inputs, audio inputs, or any other input mechanism which may be detected by a computing system.

FIG. 8 is one embodiment of a computer system that may be used with the present invention. It will be apparent to those of ordinary skill in the art, however that other alternative systems of various system architectures may also be used.

The data processing system illustrated in FIG. 8 includes a bus or other internal communication means 815 for communicating information, and a processor 810 coupled to the bus 815 for processing information. The system further comprises a random access memory (RAM) or other volatile storage device 850 (referred to as memory), coupled to bus 815 for storing information and instructions to be executed by processor 810. Main memory 850 also may be used for storing temporary variables or other intermediate information during execution of instructions by processor 810. The system also comprises a read only memory (ROM) and/or static storage device 820 coupled to bus 815 for storing static information and instructions for processor 810, and a data storage device 825 such as a magnetic disk or optical disk and its corresponding disk drive. Data storage device 825 is coupled to bus 815 for storing information and instructions.

The system may further be coupled to a display device 870, such as a cathode ray tube (CRT) or a liquid crystal display (LCD) coupled to bus 815 through bus 865 for displaying information to a computer user. An alphanumeric input device 875, including alphanumeric and other keys, may also be coupled to bus 815 through bus 865 for communicating information and command selections to processor 810. An additional user input device is cursor control device 880, such as a mouse, a trackball, stylus, or cursor direction keys coupled to bus 815 through bus 865 for communicating direction information and command selections to processor 810, and for controlling cursor movement on display device 870.

Another device, which may optionally be coupled to computer system 800, is a communication device 890 for accessing other nodes of a distributed system via a network. The communication device 890 may include any of a number of commercially available networking peripheral devices such as those used for coupling to an Ethernet, token ring, Internet, or wide area network. The communication device 890 may further be a null-modem connection, or any other mechanism that provides connectivity between the computer system 800 and the outside world. Note that any or all of the components of this system illustrated in FIG. 8 and associated hardware may be used in various embodiments of the present invention.

It will be appreciated by those of ordinary skill in the art that any configuration of the system may be used for various purposes according to the particular implementation. The control logic or software implementing the present invention can be stored in main memory 850, mass storage device 825, or other storage medium locally or remotely accessible to processor 810.

It will be apparent to those of ordinary skill in the art that the system, method, and process described herein can be implemented as software stored in main memory 850 or read only memory 820 and executed by processor 810. This control logic or software may also be resident on an article of manufacture comprising a computer readable medium having computer readable program code embodied therein and being readable by the mass storage device 825 and for causing the processor 810 to operate in accordance with the methods and teachings herein.

The present invention may also be embodied in a handheld or portable device containing a subset of the computer hardware components described above. For example, the handheld device may be configured to contain only the bus 815, the processor 810, and memory 850 and/or 825. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of the present invention for such a device would be apparent to one of ordinary skill in the art given the disclosure of the present invention as provided herein.

The present invention may also be embodied in a special purpose appliance including a subset of the computer hardware components described above. For example, the appliance may include a processor 810, a data storage device 825, a bus 815, and memory 850, and only rudimentary communications mechanisms, such as a small touch-screen that permits the user to communicate in a basic manner with the device. In general, the more special-purpose the device is, the fewer of the elements need be present for the device to function. In some devices, communications with the user may be through a touch-based screen, or similar mechanism.

It will be appreciated by those of ordinary skill in the art that any configuration of the system may be used for various purposes according to the particular implementation. The control logic or software implementing the present invention can be stored on any machine-readable medium locally or remotely accessible to processor 810. A machine-readable medium includes any mechanism for storing or transmitting information in a form readable by a machine (e.g. a computer). For example, a machine readable medium includes read-only memory (ROM), random access memory (RAM), magnetic disk storage media, optical storage media, flash memory devices, electrical, optical, acoustical or other forms of propagated signals (e.g. carrier waves, infrared signals, digital signals, etc.).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. A method for providing in-place editable static documents comprising:
generating a static document including at least one activating area, the activating area designed to cause the static document to post a message to itself, the posting enabling interaction with the static document.

2. The method of claim 1, further comprising:
upon receiving an indication on an activating area, sending an associated post message; and
interpreting the post message at a server; and
returning an update to the static document.

3. The method of claim 2, further comprising:
returning only an alteration data to the static document, because a majority of data associated with the static document display is cached on the user's system.

4. The method of claim 1, wherein the static document is an HTML document.

5. The method of claim 1, wherein the message includes a Java Server Page command, for interpretation by a server.

6. The method of claim 5, further comprising:
providing user feedback indicating an editing is taking place.

7. The method of claim 1, further comprising:
providing an echo-back feature for typing on a static document.

8. A server comprising:
a static document generation logic to generate a static document including at least one activating area;
a communications logic to make the static document available to a client;
a receiving logic to receive a post from the client, caused by an interaction with the activating area of the static document;
an interpreter to interpret a servlet associated with the post to generate an update to the static document; and
the communications logic to send the update of the static document to the client.

9. The server of claim 8, wherein the static document is an HTML document.

10. The server of claim 8, wherein the servlet is a Java serviet.

11. The server of claim 10, wherein the Java serviet is generated by a Java Server Page (JSP).

12. The server of claim 8, wherein the update to the static document does not include content cached by the client.

13. The server of claim 8, wherein the static document includes multiple frames, and the update to the static document updates only frames affected by the activating area.

14. A system comprising:
a client to display a static document including at least one activating area, the activating area designed to cause the static document to post a message to itself, and enable a user to interact with the activating area;
a server to generate the static document, receive the message from the client, and generate an update to the static document based on the message.

15. The system of claim 14, wherein the server further comprises:
an interpreter to interpret a servlet associated with the post to generate the update to the static document.

16. The system of claim 14, wherein the client further comprises:
an interaction detection logic to detect a user's interaction with the activating area, and in response generate the post.

17. The system of claim 14, wherein the client further comprises:
a receiving logic to receive an update to the static document from the server, the update generated in response to the message from the client; and
a display updating logic to refresh the static document with the update.
